(19) United States
(12) Patent Application Publication
(10) Pub. No.: US 2020/0083774 A1
(43) Pub. Date: Mar. 12, 2020

(54) METHOD FOR PRODUCING A ROTOR UNIT

(71) Applicant: SCHUNK KOHLENSTOFFTECHNIK GMBH, Heuchelheim (DE)

(72) Inventors: Guenter RINN, Lahnau (DE); Klaus-Georg TONTSCH, Biebertal (DE)

(21) Appl. No.: 16/493,549

(22) PCT Filed: Mar. 22, 2018
(86) PCT No.: PCT/EP2018/057372

§ 371 Date: Sep. 12, 2019

(30) Foreign Application Priority Data
Mar. 27, 2017 (DE) 10 2017 205 128.0

(51) Int. Cl. H02K 5/167; H02K 7/00; H02K 7/08; H02K 15/12; H02K 15/14; F04B 35/04; F16C 3/02; F16C 17/04; F16C 17/10

(52) U.S. Cl. CPC H02K 5/1672; H02K 7/003; H02K 7/083; H02K 15/12; H02K 15/14; F16C 2380/26; F16C 3/026; F16C 17/04; F16C 17/10; H02K 2205/03; F16C 2360/42; F04B 35/04

(57) ABSTRACT

The invention relates to a method for producing a rotor unit (10) of an electric motor, in particular a canned motor or the like, for driving a pump wheel of a pump and to a pump, the rotor unit being composed of a rotor (11), a shaft (12), a thrust washer (13) and sliding bearings (14, 15), the rotor being formed by a permanent magnet (22) or a shading coil, the rotor and the thrust washer being attached to the shaft, the shaft being rotatably mounted at one end (16) of the shaft and at the thrust washer by means of respective sliding bearings, the thrust washer being in contact with an axial lateral surface (21) of one of the sliding bearings (14), wherein the shaft is made from a fiber-reinforced polymer material.

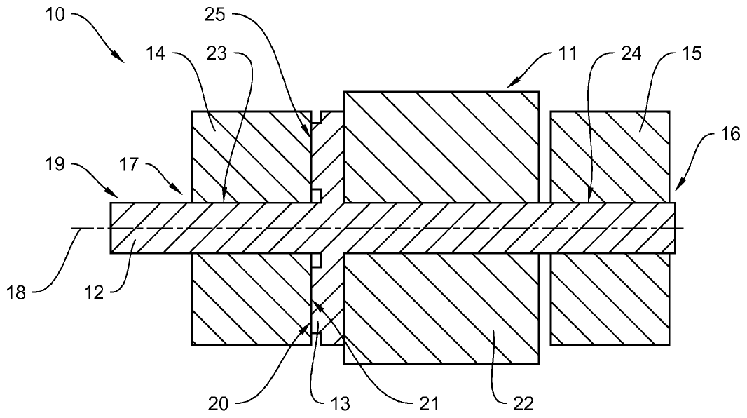

The invention relates to a method for producing a rotor unit of an electric motor and to a pump comprising an electric motor, in particular a canned motor or the like, for driving a pump wheel of the pump, the rotor unit being composed of a rotor, a shaft, a thrust washer and sliding bearings, the rotor being formed by a permanent magnet or a shading coil, the rotor and the thrust washer being attached to the shaft, the shaft being rotatably mounted at one end of the shaft and at the thrust washer by means of respective sliding bearings, the thrust washer being in contact with an axial lateral surface of one of the sliding bearings.

Canned motors are sufficiently known from the state of the art and are typically used to drive circulation pumps, such as in heating circuits. In particular, in pumps of this kind, a rotor and a stator of the electric motor are separated by a can which is disposed in an air gap between the stator and the rotor. This allows the rotor to be hermetically separated from the non-moving parts of the pump without the use of seals. The rotor is driven brushless, i.e. using a permanent-magnetic or separately excited armature of the rotor. The fluid to be pumped encircles the rotor and the sliding bearings in the pump, a pump wheel being disposed at one end of the shaft. To ensure a long service life of the pump, a sliding pairing of the shaft and of the sliding bearings has to meet special criteria. To ensure axial mounting of the rotor, a thrust washer which absorbs axial forces of the pump wheel is slipped onto the shaft. The shaft is typically made of corrosion-resistant steel or a ceramic material, such as aluminum oxide. The thrust washer can be made of these materials, as well.

Pumps for heating circuits, in particular, are exposed to pollutants or corrosion products in the heating water. Also, electrochemical corrosion of metallic materials in heating circuits occurs. Consequently, pollutant particles in a bearing gap of the shaft or roughening of a bearing surface of the shaft due to corrosion may lead to increased wear of the shaft and of the sliding bearings. Shafts made of aluminum oxide are more advantageous in this respect because they cannot corrode; however, they are very brittle and prone to fractures by comparison. Potentially present hairline cracks can cause the shaft to quickly fail during operation. Moreover, production of a rotor unit of this kind is relatively complex because of the long process times for producing the ceramic components, in particular.

Hence, the object of the present invention is to propose a method for producing a rotor unit of an electric motor that allows simple production and a pump comprising an electric motor that has an extended service life.

This object is attained by a method having the features of claim 1, a pump having the features of claim 17 and a use of a fiber-reinforced polymer material having the features of claim 18.

In a method according to the invention for producing a rotor unit of an electric motor, in particular a canned motor or the like, for driving a pump wheel or a pump, the rotor unit is composed of a rotor, a shaft, a thrust washer and sliding bearings, the rotor being formed by a permanent magnet or a shading coil, the rotor and the thrust washer being attached to the shaft, the shaft being rotatably mounted at one end of the shaft and at the thrust washer by means of respective sliding bearings, the thrust washer being in contact with an axial lateral surface of one of the sliding bearings, wherein the shaft is produced from a fiber-reinforced polymer material.

Accordingly, the shaft is radially mounted at by means of the sliding bearing at least one end, at least a second sliding bearing also serving to radially mount the shaft. At least one of the two sliding bearings forms the axial lateral surface with which the thrust washer is in contact. Accordingly, this sliding bearing also forms an axial bearing. The thrust washer is permanently connected to the shaft, allowing an axial force acting on the shaft, such as an axial force from a pump wheel, to be transmitted to the sliding bearing or, more precisely, to its axial lateral surface via the thrust washer. The fact that the shaft is produced from a fiber-reinforced polymer material makes production of the shaft substantially simpler because a series of process steps that are required when producing ceramic components, such as forming, drying, sintering, processing, etc., can be dispensed with. Moreover, with a fiber-reinforced polymer material, the shaft is unlikely to unexpectedly fail because of hairline cracks. Also, the shaft cannot corrode, which is why a service life of the shaft and thus of the rotor unit is extended while costs for production are reduced.

The thrust washer can be produced from a fiber-reinforced polymer material. In this case, the thrust washer can also be produced more simply and more cost-effectively in the manner of the shaft. For example, the thrust washer may be produced separately from the shaft, meaning that the thrust washer will be joined with the shaft during assembly of the rotor unit, such as by being slipped onto or pressed onto the shaft.

This also allows the use of identical or different materials for producing the thrust washer and the shaft.

The thrust washer can also be co-molded with the shaft. Accordingly, the shaft will form the thrust washer. Production of the shaft with the thrust washer co-molded with it can be made possible, in particular, by using the fiber-reinforced polymer material as the material for production, the polymer material significantly simplifying a forming of a shaft of this kind compared to a ceramic material.

In particular, the production from the fiber-reinforced polymer material can take place by transfer molding or injection molding. A mold or negative mold of the shaft, of the thrust washer or of the shaft including the thrust washer can be used to execute this type molding. Moreover, this type of molding allows a large number of components to be produced in little time.

Furthermore, the permanent magnet or the shading coil can be placed in a mold and be joined with the shaft by transfer molding or injection molding in the mold. In this case, the permanent magnet or the shading does not have to be pressed onto or glued to the shaft in the course of assembly. In this manner, the permanent magnet or the shading coil can be irreversibly connected to the shaft through a material-bonded and/or form-fitting connection.

The permanent magnet or the shading coil can also be enclosed, preferably fully encased, in the polymer material. From the state of the art, it is known for permanent magnets or shading coils to additionally be encapsulated on the respective shaft so as to protect them against a fluid to be pumped. This additional process step, too, can be dispensed with because the permanent magnet or the shading coil can be overmolded, i.e. enclosed, with the polymer material during the production of the shaft within the mold, allowing the permanent magnet or the shading coil to be fully embedded in the material of the shaft. Alternatively, the shaft may be provided with a recess into which the permanent magnet or the shading coil is simply inserted, the recess thus forming an enclosure.

Alternatively, the shaft can be placed into a mold and be joined with the permanent magnet by transfer molding or injection molding in the mold, wherein the permanent magnet can be made from a thermoplastic or thermosetting magnetic compound. Consequently, the finished shaft is placed in the mold and the permanent magnet is formed around the mold from the thermoplastic or thermosetting magnetic compound by transfer molding or injection molding. In this way, too, the shaft can be joined with the permanent magnet in a particularly simple manner.

Furthermore, the permanent magnet can also be magnetized in the mold. Alternatively, the permanent magnet thus produced can be magnetized after demolding.

Alternatively, the shaft and the permanent magnet can also be produced simultaneously by two-component injection molding. This can take place by two-component injection molding using a fiber-reinforced molding compound for the shaft and a polymer-bonded magnetic material.

It is particularly advantageous for the fibers to be oriented parallel at a surface of the shaft and/or at a flat angle relative to the surface of the shaft during transfer molding or injection molding. The orientation of the fibers can be a result of a flow direction of the polymer material in a mold along the surface of the shaft to be produced during transfer molding or injection molding. In this case, fiber ends are disposed at flat angles or acute angles on the surface, the fiber ends thus preventing an undesired increase of a friction coefficient at the surface, which could occur if the fiber ends were largely oriented at right angles or steep angles of >45° relative to the surface.

The sliding bearings can be realized as bearing bushes made of carbon, preferably of graphite, phenolic resin-impregnated graphite, carbonized graphite-filled phenolic resin compound, fiber-reinforced polymer or ceramics.

TABLE 1
Radial bearing and combined axial/radial bearing

| | Combined with shaft and thrust |
|---|---|
| Bearing material | washer made of |
| Carbon graphite with phenolic | fiber-reinforced polymer with or |
| resin impregnation | without tribological optimization |
| Carbonized graphite-filled | |
| phenolic resin compound | |
| Tribologically optimized | |
| fiber-reinforced polymer | |
| Fiber-reinforced polymer | fiber-reinforced polymer |
| (not tribologically optimized) | (tribologically optimized) |
| Ceramics (e.g., aluminum | |
| oxide) | |

Table 1 shows examples of possible material pairings having advantageous properties. Tribologically optimized materials are materials that have low friction coefficients and low wear rates owing to suitable additives, such as graphite, molybdenum sulfide, tungsten disulfide or PTFE. Furthermore, the clearance between the shaft and an axial bearing formed by the sliding bearing and the thrust washer can be adapted to thermal expansion coefficients and to a water absorption or swelling behavior under conditions of use. Also, hydrophobizing additives or after-treatment of the friction partners, such as by means of silicones, can be employed to reduce water absorption and swelling behavior.

Carbon fibers or glass fibers, preferably as short fibers, can be used as fibers. Short fibers can have a length of a few millimeters up to 2 cm. Alternatively, long fibers can be used when partially pre-molded molding compounds are employed, for example. In addition to the reinforcing effect of the polymer material or matrix material through the fibers, an improved friction coefficient can be achieved through the carbon fibers.

A thermoset, preferably phenolic resin, epoxy resin, polyester resin or polycyclopentadiene resin, or a thermoplastic, preferably polypropylene, polyphenylene sulfide or polyether ether ketone, can be used as the polymer material.

TABLE 2
Shaft and rotor-side axial thrust washer
made of fiber-reinforced polymers

| Fillers | | Polymeric binder | |
|---|---|---|---|
| Fibers | Other fillers | Thermoset | Thermoplastic |
| Glass fibers | Glass bubbles | Phenolic resin | Polypropylene |
| | | | (PP) |
| Carbon fibers | Mineral additives | Epoxy resin | Polyphenylene |
| | | | sulfide (PPS) |
| | Graphite | Polyester resin | Polyether ether |
| | | | ketone (PEEK) |
| | Molybdenum | Poly- | |
| | sulfide | cyclopentadiene | |
| | | resin | |
| | Tungsten disulfide | | |
| | Polytetra- | | |
| | fluoroethylene | | |

Table 2 shows examples of polymer materials as a matrix material or binder which can be advantageously combined with fibers as a filler or other supplemental fillers.

Hence, another filler, preferably graphite, molybdenum sulfide, tungsten disulfide, polytetrafluoroethylene, glass bubbles and/or mineral additives, can be added to the polymer material. In particular, the addition of another filler can improve a friction coefficient even further. In this case, a starting resistance of the shaft with the rotor is low even after a longer standstill of a pump.

In order to achieve particularly good sliding properties and a desired clearance fit between the shaft and the sliding bearings, the shaft may be machined at the bearing surfaces after production from the fiber-reinforced polymer material. Machining refers to material removal of any kind, such as by abrading or polishing. A roughness of the shaft at the bearing surfaces can be significantly reduced by such a treatment, resulting in improved sliding properties.

A friction coefficient of 0.15μ to 0.05μ, preferably 0.1μ to 0.07μ, can be produced between bearing surfaces of the shaft and sliding bearings. As was surprisingly found, these friction coefficients can be achieved simply by producing the shaft from the fiber-reinforced polymer material. In this case, the shaft can also run dry for a longer time without sustaining damage.

In the pump according to the invention, which comprises an electric motor, in particular a canned motor or the like, for driving a pump wheel of the pump, the electric motor is composed of a stator, a rotor, a shaft, a thrust washer and sliding bearings, the rotor being formed by a permanent magnet or a shading coil, the rotor, the thrust washer and the pump wheel being attached to the shaft, the shaft being rotatably mounted at one end of the shaft and at the thrust washer by means of respective sliding bearings, the thrust washer being in contact with an axial lateral surface of one of the sliding bearings, wherein the shaft is made of a fiber-reinforced polymer material. With regard to the advantages of the pump according to the invention, reference is made to the description of advantages of the method according to the invention. Other advantageous embodiments of a pump are apparent from the features of the claims dependent on claim 1.

According to the invention, a fiber-reinforced polymer material is used to produce a shaft of a canned motor of a pump, in particular a circulation pump or the like. Other advantageous embodiments of a use of the fiber-reinforced polymer material are apparent from the features of the claims dependent on claim 1 and from claim 16.

Hereinafter, an embodiment of the invention will be explained in more detail with reference to the FIGURE.

The FIGURE shows a longitudinal-section view of a rotor unit 10 of a canned motor (not shown) of a pump. Rotor unit 10 is composed of a rotor 11, a shaft 12, a thrust washer 13 and sliding bearings 14, 15. Thrust washer 13 is co-molded with shaft 12, shaft 12 thus forming thrust washer 13. Shaft 12, and with it thrust washer 13, consists of a fiber-reinforced polymer material, shaft 12 having been produced in a mold by transfer molding or injection molding. Sliding bearing 15 is disposed at one end 16 of shaft 12, sliding bearing 14 being disposed on a portion 17 of shaft 12. Bearing gaps (not illustrated) which allow rotor 11 to rotate about a longitudinal axis 18 of rotor unit 10 are formed between each of sliding bearings 14 and 15 and shaft 12. Sliding bearings 14 and 15 consist primarily of a carbonaceous material. Sliding bearing 14 simultaneously serves to axially support shaft 12 because a contact surface 20 of thrust washer 13 is in contact with a lateral surface 21 of sliding bearing 14. A pump wheel (not shown) is attached to a front end 19 of shaft 12.

Rotor 11 is formed by a permanent magnet 22 which has been produced from a now set thermosetting magnetic compound or a compound containing magnetizable particles. Alternatively, permanent magnet 22 can be made of a sintered magnet, hard ferrite or a rare-earth magnet. Shaft 12 is material-bonded to permanent magnet 22, permanent magnet 22 having been placed in a mold (not shown) and shaft 12 having been formed together with thrust washer 13 in the mold by transfer molding or injection molding. Furthermore, bearing surfaces 23, 24 and 25 of shaft 12 were after-treated and assembled with sliding bearings 14 and 15 by insertion.

1. A method for producing a rotor unit (10) of an electric motor, in particular a canned motor or the like, for driving a pump wheel of a pump, the rotor unit being composed of a rotor (11), a shaft (12), a thrust washer (13) and sliding bearings (14, 15), the rotor being formed by a permanent magnet (22) or a shading coil, the rotor and the thrust washer being attached to the shaft, the shaft being rotatably mounted at one end (16) of the shaft and at the thrust washer by means of respective sliding bearings, the thrust washer being in contact with an axial lateral surface (21) of one of the sliding bearings (14), characterized in that the shaft is produced from a fiber-reinforced polymer material.

2. The method according to claim 1, characterized in that the thrust washer (13) is produced from a fiber-reinforced polymer material.

3. The method according to claim 1, characterized in that the thrust washer (13) is co-molded with the shaft (12).

4. The method according to claim 1, characterized in that the production from the fiber-reinforced material takes place by transfer molding or by injection molding.

5. The method according to claim 4, characterized in that the permanent magnet (22) or the shading coil is placed in a mold and is joined with the shaft (12) by transfer molding or injection molding in the mold.

6. The method according to claim 4, characterized in that the permanent magnet (22) or the shading coil is enclosed, preferably fully encased, in the polymer material.

7. The method according to claim 4, characterized in that the shaft (12) is placed in a mold and is joined with the permanent magnet (22) by transfer molding or injection molding in the mold, the permanent magnet being produced from a thermoplastic or thermosetting magnetic compound.

8. The method according to claim 4, characterized in that the shaft and the permanent magnet are produced in the mold at the same time by two-component injection molding.

9. The method according to claim 7, characterized in that the permanent magnet (22) is magnetized in the mold.

10. The method according to claim 4, characterized in that the fibers are oriented parallel to a surface of the shaft (12) and/or at a flat angle relative to the surface during transfer molding or injection molding.

11. The method according to claim 1, characterized in that the sliding bearings (14, 15) are realized as bearing bushes made of carbon, preferably graphite, phenolic resin-impregnated graphite, carbonized graphite-filled phenolic resin compound, fiber-reinforced polymer or ceramics.

12. The method according to claim 1, characterized in that carbon fibers or glass fibers, preferably as short fibers, are used as fibers.

13. The method according to claim 1, characterized in that a thermoset, preferably phenolic resin, epoxy resin, polyester resin or polycyclopentadiene resin, or a thermoplastic, preferably polypropylene, polyphenylene sulfide or polyether ether ketone, is used as the polymer material.

14. The method according to claim 1, characterized in that another filler, preferably graphite, molybdenum sulfide, tungsten disulfide, polytetrafluoroethylene, glass bubbles and/or mineral additives, is added to the polymer material.

15. The method according to claim 1, characterized in that the shaft (12) is machined at bearing surfaces (23, 24, 25).

16. The method according to claim 1, characterized in that a friction coefficient of 0.15μ to 0.05μ, preferably 0.1μ to 0.07μ, is formed between bearing surfaces (23, 24, 25) of the shaft (12) and sliding bearings (14, 15).

17. A pump comprising an electric motor, in particular a canned motor or the like, for driving a pump wheel of the pump, the electric motor being composed of a stator, a rotor (11), a shaft (12), a thrust washer (13) and sliding bearings (14, 15), the rotor being formed by a permanent magnet (22) or a shading coil, the rotor, the thrust washer and the pump wheel being attached to the shaft, the shaft being rotatably mounted at one end (16) of the shaft and at the thrust washer by means of respective sliding bearings, the thrust washer being in contact with an axial lateral surface (21) of one of the sliding bearings, characterized in that the shaft is made of a fiber-reinforced polymer material.

18. A use of a fiber-reinforced polymer material for forming a shaft (12) of a canned motor of a pump, in particular a circulation pump or the like.
